(19) United States
(12) Patent Application Publication
(10) Pub. No.: US 2025/0058725 A1
(43) Pub. Date: Feb. 20, 2025

(54) VEHICLE ELECTRICAL CONTROL SYSTEM WITH DUAL VOLTAGE / DUAL APPLICATION BATTERY

(71) Applicant: Brunswick Corporation, Mettawa, IL (US)

(72) Inventors: Bruce Bultman, Zeeland, MI (US); Benjamin C. Shaffer, Bedford, NH (US); Aleksandar Lazarov, Rotterdam (NL); Christine M. Erwin, Rough and Ready, CA (US)

(73) Assignee: Brunswick Corporation, Mettawa, IL (US)

(21) Appl. No.: 18/452,240

(22) Filed: Aug. 18, 2023

(51) Int. Cl. B60R 16/033; F02N 11/04; F02N 11/08

(52) U.S. Cl. CPC B60R 16/033; F02N 11/04; F02N 11/0866; B60P 3/36; F02N 2011/0888

(57) ABSTRACT

A vehicle electrical control system for a vehicle includes a first battery having a first nominal voltage and a second battery having a second nominal voltage that is lower than the first nominal voltage. A single battery management system is electrically connected to both the first and second batteries. Both the first and second batteries are referenced to a single ground terminal. The first battery may be a starting battery and the second battery may be a house battery.

### FIELD

The present disclosure relates to vehicles requiring battery power for starting an internal combustion engine and for supplying house loads.

### BACKGROUND

U.S. Pat. No. 11,381,103, which is hereby incorporated by reference herein in its entirety, discloses a variable voltage charging system for a vehicle that includes an alternator operatively connected to an engine and configured to alternately output at least a low charge voltage to charge a low voltage storage device and a high charge voltage to charge a high voltage storage device. A switch is configured to switch between connecting the alternator to the low voltage storage device and connecting the alternator to the high voltage storage device. A controller is configured to control operation of the alternator and the switch between at least a low voltage mode and a high voltage mode. In the low voltage mode, the alternator outputs the low charge voltage and the switch is connecting the alternator to the low voltage storage device. In the high voltage mode, the alternator outputs the high charge voltage and the switch is connecting the alternator to the high voltage storage device.

### SUMMARY

This Summary is provided to introduce a selection of concepts that are further described below in the Detailed Description. This Summary is not intended to identify key or essential features of the claimed subject matter, nor is it intended to be used as an aid in limiting the scope of the claimed subject matter.

A vehicle electrical control system for a vehicle is provided in one example of the present disclosure. The vehicle electrical control system comprises a first battery having a first nominal voltage and a second battery having a second nominal voltage that is lower than the first nominal voltage. A single battery management system (BMS) is electrically connected to both the first and second batteries. The vehicle electrical control system includes a single ground terminal to which both the first and second batteries are referenced.

According to some aspects, the first battery has a higher cranking amps rating than the second battery.

According to some aspects, the vehicle electrical control system further comprises a heater adjacent the first battery, and the second battery is configured to supply power to the heater.

According to some aspects, the BMS is configured to monitor a state of charge of each of the first and second batteries. The BMS is configured to be supplied with power from the second battery as long as the second battery has a sufficient state of charge. The BMS is configured to be supplied with power from the first battery in response to the second battery not having a sufficient state of charge.

According to some aspects, the first battery is configured to supply power to a first load and the second battery is configured to supply power to a different second load. According to some aspects, the first load comprises a starter motor coupled to an engine of the vehicle and the second load comprises at least one auxiliary device on the vehicle.

According to some aspects, the vehicle electrical control system further comprises a first analog front end electrically connected between the first battery and the BMS and a second analog front end electrically connected between the second battery and the BMS.

According to some aspects, the vehicle electrical control system further comprises an alternator electrically coupled to the BMS and the first and second batteries. The BMS is configured to monitor a state of charge of each of the first and second batteries. The BMS is configured to charge the first and second batteries with power from the alternator dependent upon the respective states of charge of the first and second batteries.

According to some aspects, the vehicle electrical control system further comprises a DC/DC converter electrically coupled to the BMS and the first and second batteries. The BMS is configured to monitor a state of charge of each of the first and second batteries. The BMS is configured to control the DC/DC converter to charge the second battery with power from the first battery dependent on the respective states of charge of the first and second batteries.

According to some aspects, the first battery comprises a first plurality of cells connected in series and/or parallel with one another, and the second battery comprises a second plurality of cells connected in series and/or parallel with one another. The first plurality of cells is not connected in series with the second plurality of cells.

According to another example of the present disclosure, a vehicle electrical control system for a vehicle comprises a starting battery configured to supply power to a starter motor coupled to an engine of the vehicle. A house battery is configured to supply power to a plurality of loads on the vehicle. A single battery management system (BMS) is electrically connected to both the starting battery and the house battery.

According to some aspects, the starting battery has a first nominal voltage, and the house battery has a second nominal voltage that is lower than the first nominal voltage.

According to some aspects, the vehicle electrical control system includes a single ground terminal to which both the starting battery and the house battery are referenced.

According to some aspects, the BMS is configured to monitor a state of charge of each of the starting battery and the house battery. The BMS is configured to be supplied with power from the house battery as long as the house battery has a sufficient state of charge. The BMS is configured to be supplied with power from the starting battery in response to the house battery not having a sufficient state of charge.

According to some aspects, a first analog front end is electrically connected between the starting battery and the BMS, and a second analog front end is electrically connected between the house battery and the BMS.

According to some aspects, an alternator is electrically coupled to the BMS, the starting battery, and the house battery. The BMS is configured to monitor a state of charge of each of the starting battery and the house battery. The BMS is configured to charge the starting battery and the house battery with power from the alternator dependent upon the respective states of charge of the starting battery and the house battery.

According to some aspects, a DC/DC converter is electrically coupled to the BMS, the starting battery, and the house battery. The BMS is configured to monitor a state of charge of each of the starting battery and the house battery. The BMS is configured to control the DC/DC converter to charge the house battery with power from the starting battery dependent on the respective states of charge of the starting battery and the house battery.

According to some aspects, a heater is located adjacent the starting battery, and the house battery is configured to supply power to the heater.

According to some aspects, the starting battery comprises a first plurality of cells connected in series and/or parallel with one another. The house battery comprises a second plurality of cells connected in series and/or parallel with one another. The first plurality of cells is not connected in series with the second plurality of cells.

### BRIEF DESCRIPTION OF THE DRAWINGS

The present disclosure is described with reference to the following Figures. The same numbers are used throughout the Figures to reference like features and like components.

FIG. 1 illustrates one example of a vehicle electrical control system according to the present disclosure, with a DC/DC converter external to the battery pack.

FIG. 2 illustrates another example of a vehicle electrical control system according to the present disclosure, with a DC/DC converter internal to the battery pack.

FIG. 3 shows the layout of cells within the batteries shown in FIGS. 1 and 2.

FIG. 4 shows how the batteries and other components of the vehicle electrical control system of FIG. 1 or FIG. 2 can be packaged into a single housing.

FIG. 5 is a schematic showing various aspects of a battery management system of the vehicle electrical control system of FIG. 1 or FIG. 2.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

Unless otherwise specified or limited, the phrases “at least one of A, B, and C,” “one or more of A, B, and C,” and the like, are meant to indicate A, or B, or C, or any combination of A, B, and/or C, including combinations with multiple instances of A, B, and/or C. Likewise, unless otherwise specified or limited, the terms “mounted,” “connected,” “linked,” “supported,” and “coupled” and variations thereof are used broadly and encompass both direct and indirect mountings, connections, supports, and couplings. Further, unless otherwise specified or limited, “connected” and “coupled” are not restricted to physical or mechanical connections or couplings.

As used herein, unless otherwise limited or defined, discussion of particular directions is provided by example only, with regard to particular embodiments or relevant illustrations. For example, discussion of “top,” “bottom,” “front,” “back,” “left,” “right,” “lateral” or “longitudinal” features is generally intended as a description only of the orientation of such features relative to a reference frame of a particular example or illustration. Correspondingly, for example, a “top” feature may sometimes be disposed below a “bottom” feature (and so on), in some arrangements or embodiments. Additionally, use of the words “first,” “second”, “third,” etc. is not intended to connote priority or importance, but merely to distinguish one of several similar elements from another.

Certain internal combustion engine-powered vehicles are provided with at least two batteries, one commonly known as a starter battery, starting battery, or cranking battery, and the other commonly known as a house battery, auxiliary battery, or hotel battery. For example, multiple batteries are often provided on vehicles such as medium- and heavy-duty trucks, recreational vehicles (RVs), and boats. On a medium- or heavy-duty truck, the starting battery is used to start the engine, while the house battery is used to power temperature control devices, cabin lights, and other auxiliary electronics. On an RV, the starting battery is used to start the engine, while the house battery is used to power temperature control devices, cabin lights, kitchen devices, televisions, water pumps, heaters, etc. On a boat, the starting battery is used to start the engine of the primary propulsion device (e.g., outboard drive, stern drive, inboard drive), while the house battery is used to power a trolling motor, gauges, bilge pumps, etc.

Through research and development, the present inventors have realized that space could be maximized and cost could be minimized by combining the functionality of both a starting battery and a house battery into one battery pack, for example, into a battery pack contained within one housing. Prior art attempts to achieve the functionality of both types of batteries with a single battery pack (called dual-purpose batteries) do not have battery cells that are optimized for starting applications and for house load applications. Further, in some vehicles, it is not possible to use a dual-purpose battery for both starting and house loads because starting the engine requires a different voltage than that required to supply house loads. Thus, the present inventors have developed a dual-voltage and dual-application battery pack that is capable of being packaged into a single housing, and within which a subset of the cells are able to be optimized for starting, while another subset of the cells are able to be optimized for supplying house loads.

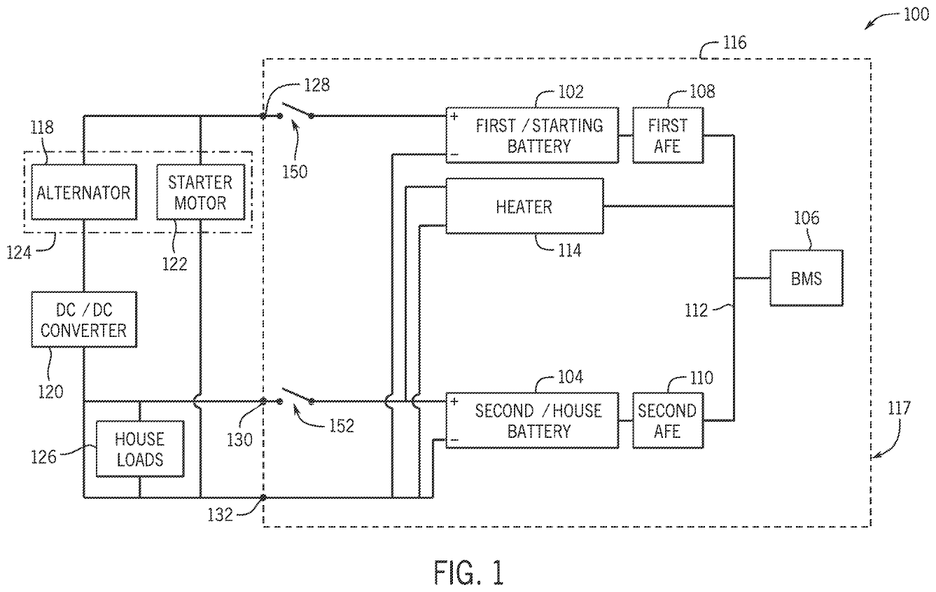

FIG. 1 shows a vehicle electrical control system 100 comprising a first battery 102 and a second battery 104. The first battery 102 has a first nominal voltage, while the second battery 104 has a second nominal voltage that is lower than the first nominal voltage. In one example, the first nominal voltage is 24V and the second nominal voltage is 12V. In other examples, the first nominal voltage is 48V and the second nominal voltage is 12V. These voltages are merely examples, and the first and second batteries 102, 104 could have nominal voltages other than discussed herein.

A single battery management system (BMS) 106 is electrically connected to both the first and second batteries 102, 104. Those having ordinary skill in the relevant art would understand that the BMS 106 is a control module that includes a microprocessor, memory, communication interface(s), integrated circuits, and semiconductors such as rectifiers and transistors, for example including MOSFETs. Together, these components enable the BMS 106 to provide protection for the batteries 102, 104 from over-charging, over-discharging, over-current, over-temperature, under-temperature, as well as to provide features such as cell balancing and/or charging. To perform such functions, the BMS 106 monitors voltage, temperature, current, and state of charge and/or health, among other states of the batteries 102, 104. Thus, the BMS 106 is provided with information from temperature sensors, voltage sensors, and current sensors (not shown) associated with the cells in each battery 102, 104, as is known in the art. The BMS 106 shown here is a centralized BMS, with a single controller connected to each cell of the batteries 102, 104, although not all connections are shown here. Although it is a single module, the BMS 106, 206 can be provided on one or more circuit boards.

A first analog front end 108 is electrically connected between the first battery 102 and the BMS 106, and a second analog front end 110 is electrically connected between the second battery 104 and the BMS 106. Each analog front end (AFE) 108, 110 includes A/D converters, voltage references, multiplexers, and a bus interface and is coupled to the respective battery 102, 104 to assess the status of the battery or its cells, such as their voltage and temperature. The AFEs 108, 110 transfer such data indicative of the status of the batteries or their cells to the microprocessor of the BMS 106 for various purposes, such as battery protection. The AFEs 108, 110 are further configured to provide level shifting of the cells in the batteries 102, 104 by internally de-stacking the voltages of the cells and bringing them to ground reference, thereby providing the BMS 106 with accurate voltage measurements across each cell. The AFEs 108, 110 also have internal A/D converters that convert the analog measurements from the sensors to digital values that the BMS 106 uses to determine state of charge (SoC) and to make decisions about cell balancing. The AFEs 108, 110 may further be configured to remove energy from a particular cell in a stack without removing energy from all cells for purposes of cell balancing. A communication bus 112, such as a serial peripheral interface (SPI) or inter-integrated circuit (I²C) is provided between the BMS 106 and each AFE 108, 110. The use of a common ground terminal 132 (discussed herein below) to which both batteries 102, 104 are referenced enables the use of two AFEs 108, 119 with the common microprocessor of the BMS 106.

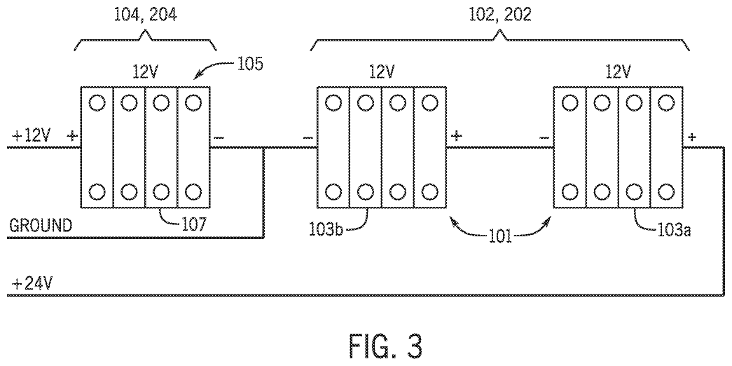

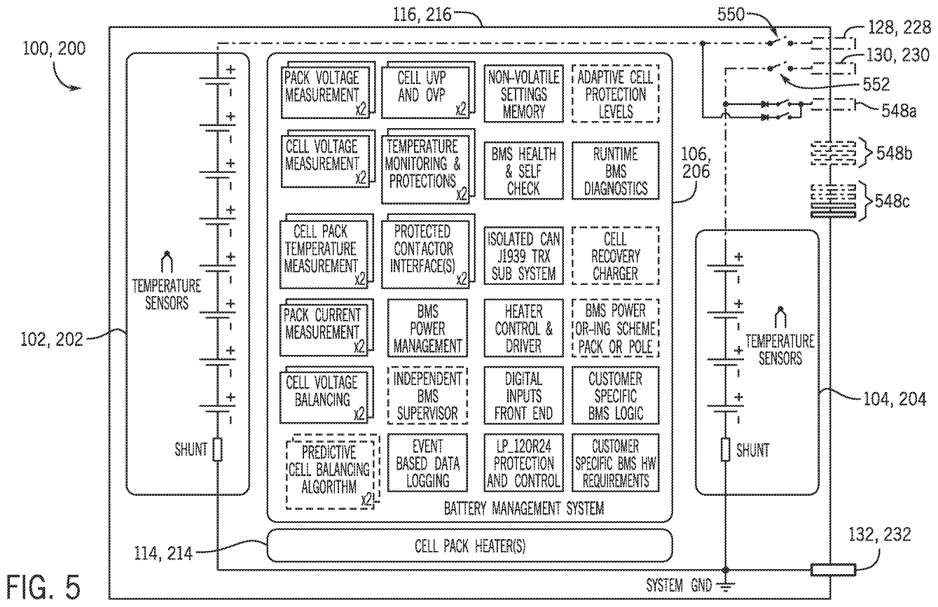

The vehicle electrical control system 100 further comprises a heater 114 adjacent the first battery 102. The heater 114 may be a resistive heater, a thermoelectric device (TED), or another type of heater. The heater 114 may comprise a heater driver circuit (not shown, but see FIG. 5) in communication with the BMS 106 via the bus 112. In another example, the heater drive circuit is independently wired to the BMS 106. As shown herein, the second battery 104 is configured to supply power to the heater 114, for reasons that will be discussed further herein below. In another example, a heater is provided for heating the second battery 104 as well, which second heater is also powered by the second battery 104. In still another example, a respective heater is provided for each of the two modules 103a, 103b (FIG. 3) of the first battery 102, both of which heaters are powered by the second battery 104.

Each of the first and second batteries 102, 104, the first and second AFEs 108, 110, the BMS 106, and the heater 114 are packaged inside a single enclosure or housing 116, thereby forming a single battery pack 117 that can be installed into a vehicle. In this example, the remainder of the vehicle electrical control system 100 is provided externally of the housing 116 and includes an alternator 118 and a DC/DC converter 120. A first positive terminal 128, second positive terminal 130, and ground terminal 132 are provided for connection of the components inside the housing 116 to components outside the housing 116. The voltage output of the first battery 102 is provided to the first positive terminal 128, while the voltage output of the second battery 104 is provided to the second positive terminal 130. The battery pack 117 includes a single ground terminal 132 to which both the first and second batteries 102, 104 are referenced. In other words, the negative terminals of both the first and second batteries 102, 104 are directly connected to the common ground terminal 132.

In the present example, the first battery 102 is configured to supply power to a first load via the first positive terminal 128 and the second battery 104 is configured to supply power to a different second load via the second positive terminal 130. As shown, the first load comprises a starter motor 122 coupled to an engine 124 of the vehicle and the second load comprises at least one auxiliary device (i.e., house loads 126) on the vehicle.

The alternator 118 is provided along with a starter motor 122 on the vehicle's engine 124, which in this example is an internal combustion engine. As is known, the alternator 118 is an electrical generator that converts the mechanical energy of the engine 124 to electrical energy. The alternator 118 includes an internal rectifier that converts the generated alternating current to direct current. The DC/DC converter 120 may be a bidirectional DC/DC converter and may include both a buck DC/DC converter and a boost DC/DC converter. As is known, the DC/DC converter 120 is configured to convert current from one voltage level to another. In the present example, the DC/DC converter 120 is at least capable of stepping down the voltage of the current generated by the alternator 118 to a level that can be supplied to charge the second battery 104. In the example of FIG. 1, the DC/DC converter 120 is external to the housing 116 and is provided in the vehicle. This provides several advantages, such as freeing up more space in the housing 116 for energy storage (or allowing the housing 116 to be smaller than it might otherwise be) and locating a heat-generating device outside of the housing 116.

As shown, the first battery 102 is electrically coupled to the starter motor 122 and the alternator 118 via the first positive terminal 128 provided on the housing 116. The first battery 102 is configured to supply electrical power to the starter motor 122 to start the engine 124 upon activation of a switch in a starting circuit, as is known. Typically, such a starter motor 122 will require a short pulse of high power in order to cause the engine 124 to turn over. The first battery 102 therefore is provided with a high cranking amps (CA) rating. The CA rating is the amount of electricity that the battery can supply for a given amount of time under certain environmental conditions while maintaining a given voltage (e.g., the number of amps the battery can deliver for 30 seconds at a given temperature, e.g. 0° C., before its voltage drops below a given value). In some instances, the CA rating is a cold cranking amps (CCA) rating based on battery operation at −18° C. Meanwhile, the second battery 104 is configured to supply electrical power to house loads 126 (examples of which are listed hereinabove) on the vehicle via the second positive terminal 130. Typically, for this purpose, the second battery 104 will be provided with the ability to supply steady power for a long duration/run-time. The second battery 104 therefore is provided with a high Amp/Hours (Ah) rating (the amount of steady current that the battery can provide for a given amount of time under a given load).

Because the first battery 102 is used for starting the engine 124, while the second battery 104 is used to power house loads, in one example, the first battery 102 has a higher voltage and a higher cranking amps rating than the second battery 104. In one non-limiting example, the first battery 102 is a 24V battery rated 1600 CA/sec @ 0° C. and 600 CA/15 sec @ 0° C. The first battery 102 may have an energy storage capacity of 66 Ah. The second battery 104 may be a 12V battery with an energy storage capacity of 100 Ah. The CA rating of the second battery 104 may be lower than that of the first battery 102. In some aspects, the design of the second battery 104 is such that the second battery 104 is not particularly suitable for cranking due to the second battery 104 having thinner plates for higher energy density, as will be described further herein below. Both of the batteries 102, 104 are rechargeable and may be Lithium-ion batteries, lead-acid batteries, absorbed glass mat batteries, or other types of rechargeable batteries suitable for use on a vehicle such as a truck, RV, or boat. In the present example, both batteries 102, 104 are Lithium-ion batteries, specifically Lithium-Iron-Phosphate (LFP) batteries, but other types of Lithium-ion batteries could be used.

Turning briefly to FIG. 3, a schematic of the first and second batteries 102, 104 is shown. It can be seen that the first battery 102 comprises a first plurality of cells 101 connected in series and/or parallel with one another. The first plurality of cells 101 is in this example divided into two battery modules 103a, 103b, each module comprising four cells, and each cell having a 3V potential. Thus, each module 103a, 103b in the first battery 102 has a nominal voltage of 12V. The two modules 103a, 103b are connected in series to provide a total of 24V to the first battery 102. The second battery 104 comprises a second plurality of cells 105 connected in series and/or parallel with one another. In the second battery 104, all four cells, each having a 3V potential, are combined in a single 12V module 107. It can be seen that the first plurality of cells 101 of the first battery 102 is not connected in series with the second plurality of cells 105 of the second battery 104. Further, the negative terminals of the module 103b and the module 107 are connected to the same ground reference. This is in contrast to prior art dual-voltage battery systems, which use a ground tap into a series-stacked battery pack to obtain a desired voltage.

Each plurality of cells 101, 105 is specifically designed for the load the respective battery 102, 104 is intended to supply. In general, the plates in the first plurality of cells 101 have a design that allows them to withstand a large number of high-current discharges and to recharge quickly, as is required for supplying power to a starting motor on an engine. The plates in the second plurality of cells 105 are designed to be deeply discharged before the second battery 104 requires recharging, which takes longer than recharging of the first battery 102. Further, the first battery 102 may be provided with a higher-gauge current carrier in order to handle the higher pulse current, while the second battery 104 may be provided with a lower-gauge current carrier. In an example in which the batteries 102, 104 are lead-acid batteries, the cells in the first plurality of cells 101 in the first battery 102 are constructed of plates that are thinner and more numerous than the plates forming the cells in the second battery 104, and the plates forming the second plurality of cells 105 are thicker and fewer in number than the plates in the first battery 102. In an example in which the batteries 102, 104 are Lithium-ion batteries, the cells in the first plurality of cells 101 have thicker copper plates with a thinner active material layer, while the cells in the second plurality of cells 105 have thinner copper plates but a much thicker active material layer.

Returning to FIG. 1, the BMS 106 itself must be provided with power to function. If the battery that is intended to supply the BMS 106 with power is drained to the point where it can no longer power the BMS 106, then the vehicle (or at least the battery) may need to be returned to an OEM or dealer for factory reset. The present inventors have realized that an advantage of having two batteries 102, 104 connected to a single BMS allows both batteries to be alternately used to power the BMS. As noted, the BMS 106 is configured to monitor a state of charge (SoC) of each of the first and second batteries 102, 104. The BMS 106 is configured to be supplied with power from the second battery 104 as long as the second battery 104 has a sufficient SoC (i.e., at least a given threshold SoC). This is because, as noted above, the second battery 104 is designed to provide consistent power for a long run-time, which is ideal for functioning of the BMS 106. However, the BMS 106 is configured to be supplied with power from the first battery 102 in response to the second battery 104 not having a sufficient SoC (i.e., a SoC below the given threshold). For instance, the BMS 106 can be configured to disconnect the second battery 104 from its power input terminal and to connect the first battery 102 to its power input terminal instead. Advantageously, because the BMS 106 can be powered from either battery 102 or 104, it is possible for the BMS 106 to determine which battery is depleted. If the BMS 106 could no longer function due to lack of power, it would not be capable of determining that the depleted battery needed to be recharged. In a further example, the BMS 106 can be powered by applying an external voltage across the battery terminals 128 and 132 or 130 and 132. The external voltage will cause contactor 150 or 152 to close such that the BMS 106 can be powered even if both batteries 102, 104 are dead.

It is possible for one or both of the batteries 102, 104 to be depleted and require recharging. In a vehicle electrical control system in which the starting battery and the house battery are provided with separated BMSs, each BMS must communicate its respective SoC to a higher level controller (e.g., a controller on the vehicle), which higher level controller then needs to be configured to recharge and/or balance the charges of the two batteries. The configuration of the vehicle controller to perform such functions may not be specific to the given battery. In contrast, the BMS 106 is specific to the battery pack 117 and can be configured accordingly. For instance, the present inventors have designed a system in which the single BMS 106 is able to request power from the external alternator 118 and the external DC/DC converter 120 to recharge one or both of the batteries 102, 104 and/or to balance the charges of the batteries 102 and 104. As shown, the alternator 118 is electrically coupled to the BMS 106 and to the first and second batteries 102, 104. The alternator 118 is connected to the first battery 102 via the first positive terminal 128 and to the second battery 104 via the DC/DC converter 120 and the second positive terminal 130. As it monitors SoC, the BMS 106 is configured to charge the first and second batteries 102, 104 with power from the alternator 118 dependent upon the respective states of charge of the first and second batteries 102, 104. For instance, if the BMS 106 determines that the SoC of the first battery 102 is below a given threshold, the BMS 106 will communicate with the vehicle controller to determine if the engine 124 is running and, if so, will electrically connect the alternator 118 to the first battery 102 for charging thereof. If the BMS 106 determines that the SoC of the second battery 104 is below a given threshold, the BMS 106 will communicate with the vehicle controller to determine if the engine 124 is running and, if so, request that the vehicle controller electrically connect the alternator 118 to the DC/DC converter 120. The BMS 106 will in turn electrically connect the DC/DC converter 120 to the second battery 104 for charging thereof. In other examples, the BMS 106 is configured to control the DC/DC converter 120 directly via a controller-area network (CAN) bus rather than relying on the vehicle controller to control the DC/DC converter 120. If both the first and second batteries 102, 104 have low SoC, the BMS 106 may be configured to charge both batteries at the same time or to prioritize charging one battery over the other, for example, based on the state of the vehicle and/or based on which battery has a lower SoC.

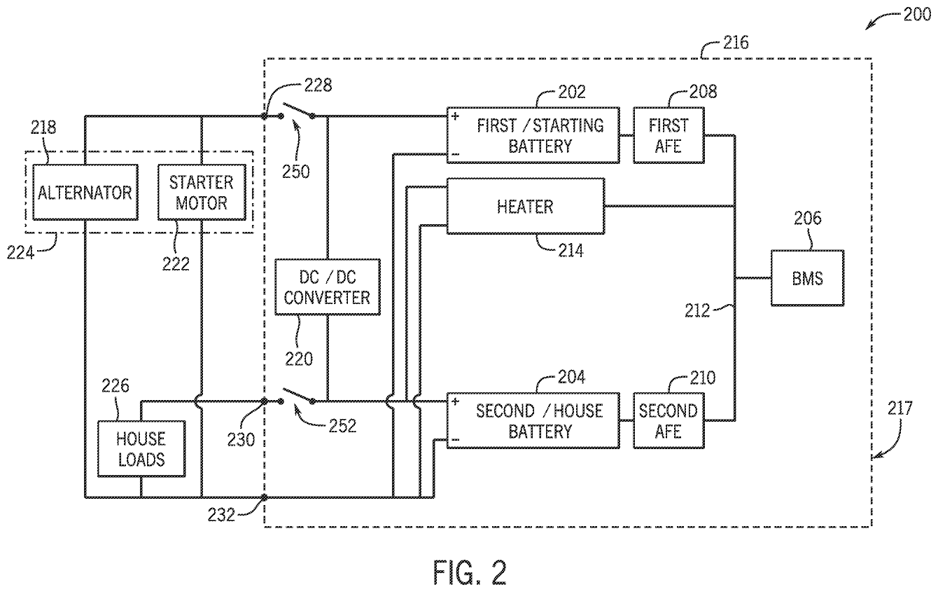

FIG. 2 shows another example of a vehicle electrical control system 200 according to the present disclosure. The vehicle electrical control system 200 includes a first battery 202 having a first nominal voltage and a second battery 204 having a second nominal voltage that is lower than the first nominal voltage. A single battery management system (BMS) 206 is electrically connected to both the first and second batteries 202, 204. A first analog front end 208 is electrically connected between the first battery 202 and the BMS 206, and a second analog front end 210 is electrically connected between the second battery 204 and the BMS 206. Both the first and second batteries 202, 204 are referenced to a single ground terminal 232. A heater 214 is located adjacent the first battery 202, and the second battery 204 is configured to supply power to the heater 214. The first battery 202 is configured to supply power to a first load (the starter motor 222) and the second battery 204 is configured to supply power to a different second load (the house loads 226).

The above-mentioned components of the vehicle electrical control system 200 operate in the same or similar manners to like-numbered components of the vehicle electrical control system 100 of FIG. 1, with like components being labeled with a “2” in the hundreds place instead of a “1” and the same two digits in the tens and ones places. However, in FIG. 2 the DC/DC converter 220 (which is electrically coupled to the BMS 206 and the first and second batteries 202, 204) is located inside the housing 216 and forms part of the battery pack 217. Similar to the BMS 106, the BMS 206 is configured to monitor a state of charge of each of the first and second batteries 202, 204. Unlike the BMS 106, the BMS 206 is configured to control the DC/DC converter 220 directly to charge the second battery 204 with power from the first battery 202 dependent on the respective states of charge of the first and second batteries 202, 204. For instance, if the SoC of the first battery 202 is above a given threshold and the SoC of the second battery 204 is below a given threshold, the BMS 206 will connect the positive terminals of the batteries 202, 204 via the DC/DC converter 220 to step down the 24V of the first battery 202 to 12V to charge the second battery 204. Such an arrangement may be particularly useful when the vehicle electrical control system 200 is one installed on an RV or a boat, where the engine 224 may not be run for a significant period of time, but the house loads 226 are on and draining the second battery 204. For instance, on an RV, the vehicle may remain parked with its engine 224 off for a significant period of time while the kitchen appliances, water pumps, etc. (all of which are powered by the second battery 204) are used. On a boat, the primary propulsion device's engine 224 may remain off for a significant period of time while the trolling motor (which is powered by the second battery 204) is used to provide thrust to propel the boat through the water. The BMS 206 can directly control electronic switches to divert power from the first battery 202 through the DC/DC converter 220 to the second battery 204, without requiring action by a higher-level controller external to the housing 216.

As with the example of FIG. 1, in the vehicle electrical control system 200 of FIG. 2, an alternator 218 is electrically coupled to the BMS 206 and the first and second batteries 202, 204. The alternator 218 can be used to charge the first battery 202 when the BMS 206 determines that the first battery 202 has fallen below a given SoC. Although an external DC/DC converter is not shown, one could be provided between the alternator 218 and the second battery 204 to step down the voltage from the alternator 218 and charge the second battery 204, as described above with respect to FIG. 1.

The present disclosure is thus of a vehicle electrical control system 100, 200 for a vehicle. The vehicle electrical control system 100, 200 comprises a starting battery 102, 202 configured to supply power to a starter motor 122, 222 coupled to an engine 124, 224 of the vehicle. A house battery 104, 204 is configured to supply power to a plurality of loads (e.g. house loads 126, 226) on the vehicle. A single battery management system (BMS) 106, 206 is electrically connected to both the starting battery 102, 202 and the house battery 104, 204.

In some aspects, the starting battery 102, 202 has a first nominal voltage and the house battery 104, 204 has a second nominal voltage that is lower than the first nominal voltage.

In some aspects, the vehicle electrical control system 100, 200 includes a single ground terminal 132, 232 to which both the starting battery 102, 202 and the house battery 104, 204 are referenced.

In some aspects, the BMS 106, 206 is configured to monitor a state of charge of each of the starting battery 102, 202 and the house battery 104, 204. The BMS is configured to be supplied with power from the house battery 104, 204 as long as the house battery 104, 204 has a sufficient state of charge. The BMS 106, 206 is configured to be supplied with power from the starting battery 102, 202 in response to the house battery 104, 204 not having a sufficient state of charge.

In some aspects, a first analog front end 108, 208 is electrically connected between the starting battery 102, 202 and the BMS 106, 206, and a second analog front end 110, 210 is electrically connected between the house battery 104, 204 and the BMS 106, 206.

In some aspects, an alternator 118 is electrically coupled to the BMS 106, the starting battery 102, and the house battery 104. The BMS 106 is configured to monitor a state of charge of each of the starting battery 102 and the house battery 104. The BMS 106 is configured to charge the starting battery 102 and the house battery 104 with power from the alternator 118 dependent upon the respective states of charge of the starting battery 102 and the house battery 104.

In some aspects, a DC/DC converter 220 is electrically coupled to the BMS 206, the starting battery 202, and the house battery 204. The BMS 206 is configured to monitor a state of charge of each of starting battery 202 and the house battery 204. The BMS 206 is configured to control the DC/DC converter 220 to charge the house battery 204 with power from the starting battery 202 dependent on the respective states of charge of the starting battery 202 and the house battery 204.

In some aspects, a heater 114, 214 is located adjacent the starting battery 102, 202, and the house battery 104, 204 is configured to supply power to the heater 114, 214. Configuring the vehicle electrical control system 100, 200 such that the heater 114, 214 is powered by the house battery 104, 204 ensures that consistent, long-duration power can be provided to the heater 114, 214 when needed. Further, it is often the case that the starting battery 102, 202 will be the battery requiring heating, such as when the vehicle is started on a cold day. It would be counterproductive to have the starting battery 102, 202 use its own energy to power its own heater 114, 214.

Referring to FIG. 3, in some aspects, the starting battery 102, 202 comprises a first plurality of cells 101 connected in series and/or parallel with one another. The house battery 104, 204 comprises a second plurality of cells 105 connected in series and/or parallel with one another. The first plurality of cells 101 is not connected in series with the second plurality of cells 105.

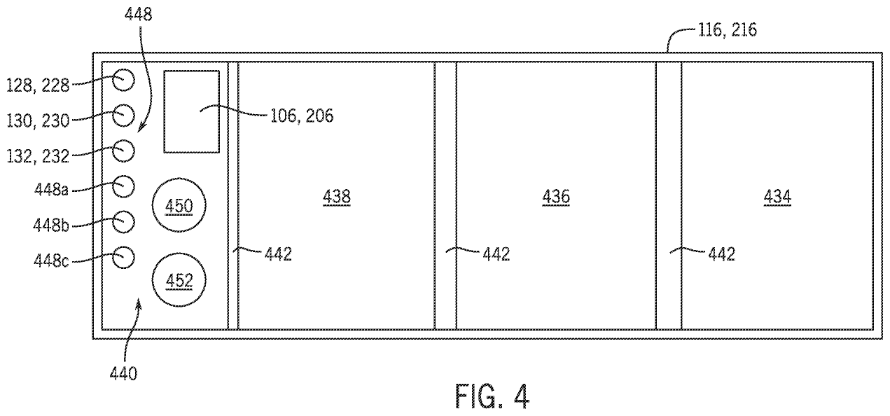

FIG. 4 shows a plan (top-down) view of a housing 116, 216 of the battery packs 117, 217 described hereinabove. The housing 116, 216 includes four pockets 434, 436, 438, 440, each of which is separated by a wall 442. The walls 442 extend laterally across the housing 116, 216, from one side of a frame 444 of the housing 116, 216 to the other. The pockets 434, 436, 438, 440 are each rectangular recessed spaces separated by the walls 442. The walls 442 may not extend the full depth of the housing 116, 216 to allow for airflow under portions of the housing 116, 216 and around the pockets 434, 436, 438, 440. The pocket 434 is configured to house the module 103a of the first battery 102, 202, and the pocket 436 is configured to house the module 103b of the first battery 102, 202. The pocket 438 is configured to house the module 107 of the second battery 104. The pocket 440 is configured to house the BMS 106, 206 and any relays or contactors 450, 452 required between the batteries and the connectors 448. In another example, the BMS 106, 206 is situated on top of one of the walls 442. The pocket 440 also holds the connectors 448 providing for inputs to and outputs from the battery pack 117, 217. For example, the connectors 448 may include the first positive terminal 128, 228, the second positive terminal 130, 230, and the ground terminal 132, 232. Other connectors 448 may include a low power output connector 448a, a digital input connector 448b, and a communication bus connector 448c. All of the connectors 448 may be touch-safe waterproof connectors. The housing 116, 216 is provided with a lid, which has the same size and shape as the lower portion of the housing 116, 216 shown here, and which when attached to the lower portion of the housing forms a sealed battery pack 117, 217.

The housing 116, 216 can be fastened to the vehicle in a robust manner, such as by fastening the lower portion of the housing directly to the vehicle chassis with bolts or other fasteners. If the batteries are Lithium-ion batteries, they are maintenance free and so the housing 116, 216 can be placed in a location that is difficult to access on the chassis, providing flexibility. The housing 116, 216 also provides advantages in that only one electromagnetic interference shield (e.g., a Faraday cage) needs to be provided, which shields both batteries, the BMS, and other electronics within the housing. Further, a single pressure vent may be provided for venting gases from the housing 116, 216 to the atmosphere. The vent may operate in a first mode in which pressures inside and outside the housing 116, 216 are equalized as temperature and/or altitude change. In a second mode, the vent may vent gases generated by the battery cells. Such a dual-mode pressure vent is not inexpensive, and being able to provide only one vent on a single housing for both batteries therefore presents cost savings.

FIG. 5 is a schematic used to illustrate some of the functionality of the BMS 106, 206. The BMS 106, 206 is provided in the housing 116, 216 along with the batteries 102, 202 and 104, 204. The first/starting battery 102, 202 is connectable to the first positive terminal 128, 228 via a first contactor 550, and the second/house battery 104, 204 is connectable to the second positive terminal 130, 230 via a second contactor 552. Both batteries 102, 202 and 104, 204 are connected to a common ground terminal 132, 232. Connections are schematically shown for low power output at 548a, for digital inputs at 548b, and for bus communication and power at 548c. Only the main electrical connections are shown in FIG. 5, but it would be understood by one of ordinary skill in the art how a circuit board could be designed to provide the appropriate electrical connections.

The BMS 106, 206 is provided with the ability to measure the voltage of each battery, the voltage of each cell within each battery, the temperature of the cells, and the current of each battery. The BMS 106, 206 is provided with a cell voltage balancing algorithm and optionally with a predictive cell balancing algorithm. The BMS 106, 206 further is configured to provide cell under-voltage and over-voltage protection and temperature monitoring and protection. The BMS 106, 206 is also configured to provide protected contactor interfaces, power management, an independent supervisor, and event-based data logging. The BMS 106, 206 has a non-volatile memory, which is shared for both batteries 102, 202 and 104, 204. The BMS 106, 206 is configured to run a health and self-check. The BMS 106, 206 includes a bus interface, such as an interface for communication with a vehicle CAN bus via the connections shown at 548c. The vehicle CAN bus may operate using a higher layer protocol such as SAE J1939, NMEA 2000, or RV-C, or other known protocol as appropriate for the vehicle type. The BMS 106, 206 may include or may control the heater controller and driver for the heater 114, 214. The BMS 106, 206 has an interface for receiving front end digital inputs and is equipped with low power protection and control algorithms. The BMS 106, 206 includes an adaptive cell protection module, a runtime BMS diagnostics module, a cell recovery charging module, and an OR-ing module for selecting between power sources. In some instances, the BMS 106, 206 may include customer-specific logic and/or hardware.

By providing only one processor, only one non-volatile memory and only one CAN stack for communication via the external bus, the present vehicle electrical control systems 100, 200 provide improvements over prior art systems with a separate BMS for each battery. For instance, having only one processor means that the quiescent load on the system is less than it would be were there two or more BMSs, each with its own processor. Lesser quiescent load means the batteries last longer between charges. Having only one CAN stack means there are fewer messages on the vehicle's bus, as opposed to two or more BMSs sending messages over the bus.

As noted, the vehicle electrical control systems 100, 200 can be used on a boat or in an RV. In a marine application, it may be desirable to provide a single battery pack housing three batteries with three different voltages (e.g., 12V, 24V, and 36V). Thus, the present disclosure is not limited to a battery pack with two batteries/voltages. In both a boat and an RV, the fact that the vehicle would have a larger energy storage battery to rely on could be used to maximize space. For instance, on a boat, navigation lights and trim control systems are required to have a minimum reserve capacity and are typically connected to the starting battery. The starting battery could be made smaller if the large reserve capacity of the house battery was instead able to be relied upon. In other words, more space could be devoted to the energy side of the battery (i.e., the cells 105 in the house battery 104, 204) if the battery pack 117, 217 is used with a smaller engine requiring less starting power, without changing the overall external size of the battery pack 117, 217. In some instances, it may be desirable to provide a module external to the housing 116, 216 that splits the ground into two. For example, some marine engines require isolated starting and charging circuits, while the house battery may be grounded. While the aspects noted immediately above apply mainly to boat and RV battery systems, in some instances, they may be equally applicable to medium- or heavy-duty truck applications.

In the above description, certain terms have been used for brevity, clarity, and understanding. No unnecessary limitations are to be inferred therefrom beyond the requirement of the prior art because such terms are used for descriptive purposes and are intended to be broadly construed. The order of method steps or decisions shown in the Figures and described herein are not limiting on the appended claims unless logic would dictate otherwise. It should be understood that the decisions and steps can be undertaken in any logical order and/or simultaneously. The different systems and methods described herein may be used alone or in combination with other systems and methods. It is to be expected that various equivalents, alternatives and modifications are possible within the scope of the appended claims.

What is claimed is:

1. A vehicle electrical control system for a vehicle comprising:
a first battery having a first nominal voltage;
a second battery having a second nominal voltage that is lower than the first nominal voltage;
a single battery management system (BMS) electrically connected to both the first and second batteries; and
a single ground terminal to which both the first and second batteries are referenced.

2. The vehicle electrical control system of claim 1, wherein the first battery has a higher cranking amps rating than the second battery.

3. The vehicle electrical control system of claim 2, further comprising a heater adjacent the first battery, wherein the second battery is configured to supply power to the heater.

4. The vehicle electrical control system of claim 2, wherein the BMS is configured to monitor a state of charge of each of the first and second batteries;
wherein the BMS is configured to be supplied with power from the second battery as long as the second battery has a sufficient state of charge; and
wherein the BMS is configured to be supplied with power from the first battery in response to the second battery not having a sufficient state of charge.

5. The vehicle electrical control system of claim 1, wherein the first battery is configured to supply power to a first load and the second battery is configured to supply power to a different second load.

6. The vehicle electrical control system of claim 5, wherein the first load comprises a starter motor coupled to an engine of the vehicle, and the second load comprises at least one auxiliary device on the vehicle.

7. The vehicle electrical control system of claim 1, further comprising a first analog front end electrically connected between the first battery and the BMS, and a second analog front end electrically connected between the second battery and the BMS.

8. The vehicle electrical control system of claim 1, further comprising an alternator electrically coupled to the BMS and the first and second batteries;
wherein the BMS is configured to monitor a state of charge of each of the first and second batteries; and
wherein the BMS is configured to charge the first and second batteries with power from the alternator dependent upon the respective states of charge of the first and second batteries.

9. The vehicle electrical control system of claim 1, further comprising a DC/DC converter electrically coupled to the BMS and the first and second batteries;
wherein the BMS is configured to monitor a state of charge of each of the first and second batteries; and
wherein the BMS is configured to control the DC/DC converter to charge the second battery with power from the first battery dependent on the respective states of charge of the first and second batteries.

10. The vehicle electrical control system of claim 1, wherein the first battery comprises a first plurality of cells connected in series and/or parallel with one another;
wherein the second battery comprises a second plurality of cells connected in series and/or parallel with one another; and
wherein the first plurality of cells is not connected in series with the second plurality of cells.

11. A vehicle electrical control system for a vehicle comprising:
a starting battery configured to supply power to a starter motor coupled to an engine of the vehicle;
a house battery configured to supply power to a plurality of loads on the vehicle; and
a single battery management system (BMS) electrically connected to both the starting battery and the house battery.

12. The vehicle electrical control system of claim 11, wherein the BMS is configured to monitor a state of charge of each of the starting battery and the house battery;
wherein the BMS is configured to be supplied with power from the house battery as long as the house battery has a sufficient state of charge; and
wherein the BMS is configured to be supplied with power from the starting battery in response to the house battery not having a sufficient state of charge.

13. The vehicle electrical control system of claim 11, further comprising a first analog front end electrically connected between the starting battery and the BMS, and a second analog front end electrically connected between the house battery and the BMS.

14. The vehicle electrical control system of claim 11, further comprising an alternator electrically coupled to the BMS, the starting battery, and the house battery;
wherein the BMS is configured to monitor a state of charge of each of the starting battery and the house battery; and
wherein the BMS is configured to charge the starting battery and the house battery with power from the alternator dependent upon the respective states of charge of the starting battery and the house battery.

15. The vehicle electrical control system of claim 11, further comprising a DC/DC converter electrically coupled to the BMS, the starting battery, and the house battery;
wherein the BMS is configured to monitor a state of charge of each of starting battery and the house battery; and
wherein the BMS is configured to control the DC/DC converter to charge the house battery with power from the starting battery dependent on the respective states of charge of the starting battery and the house battery.

16. The vehicle electrical control system of claim 11, wherein the starting battery comprises a first plurality of cells connected in series and/or parallel with one another;
wherein the house battery comprises a second plurality of cells connected in series and/or parallel with one another; and
wherein the first plurality of cells is not connected in series with the second plurality of cells.

17. The vehicle electrical control system of claim 11, further comprising a single ground terminal to which both the starting battery and the house battery are referenced.

18. The vehicle electrical control system of claim 11, wherein the starting battery has a first nominal voltage and the house battery has a second nominal voltage that is lower than the first nominal voltage.

19. The vehicle electrical control system of claim 11, further comprising a heater adjacent the starting battery, wherein the house battery is configured to supply power to the heater.
